(19) United States
(12) Patent Application Publication
(10) Pub. No.: US 2008/0292435 A1
(43) Pub. Date: Nov. 27, 2008

(54) ATV LOADING DEVICE

(76) Inventors: Gary D. Turner, Rockwall, TX (US); Christopher L. Turner, Forney, TX (US); Michael L. Turner, Parker, SD (US)

Correspondence Address: MICHAEL A. O'NEIL, P.C., 5949 SHERRY LANE, SUITE 820, DALLAS, TX, 75225, US

(21) Appl. No.: 12/123,915

(22) Filed: May 20, 2008

Related U.S. Application Data
(60) Provisional application No. 60/939,395, filed on May 22, 2007.

(51) Int. Cl. B60P 9/00

(52) U.S. Cl. 414/462

(57) ABSTRACT

An ATV loading device for loading and transporting objects using an ATV, comprising a primary frame component, a secondary frame component attached to the primary frame component, a bumper positioning component attached to the secondary frame component for bracing the ATV loading device against a bumper of an ATV, a bumper saddle attached to the primary frame component for bracing the ATV loading device against a bumper of an ATV, a detachable basket support arm pivotally attached to the secondary frame component, and a detachable basket removably attached to the detachable basket support arm for loading and transporting objects.

### CROSS-REFERENCE TO RELATED APPLICATION

Applicant claims priority based on provisional patent application Ser. No. 60/939,395 filed May 22, 2007, the entire content of which is incorporated herein by reference.

### BRIEF DESCRIPTION OF THE DRAWINGS

A more complete understanding of the ATV loading device may be had by reference to the following Detailed Description when taken in connection with the accompanying Drawings, wherein:

FIG. 1 is a perspective view of an embodiment of the ATV loading device;

FIG. 2 is a frontal view of an embodiment of the ATV loading device;

FIG. 3 is an exploded view of primary frame component and secondary frame component portions of an embodiment of the ATV loading device;

FIG. 4 is an exploded perspective view of an embodiment of the ATV loading device;

FIG. 5 is an inverted view of FIG. 4;

FIG. 6 is a frontal view of an embodiment of the ATV loading device mounted on an ATV;

FIG. 7 is a side-elevational view of an embodiment of the ATV loading device mounted on an ATV without a load;

FIG. 8 is a perspective view of an embodiment of the ATV loading device mounted on an ATV;

FIG. 9 is a side-elevational view of an embodiment of the ATV loading device mounted on an ATV with a load in a lowered position;

FIG. 10 is a side-elevational view of an embodiment of the ATV loading device mounted on an ATV with a load in an elevated intermediate position;

FIG. 11 is a side-elevational view of an embodiment of the ATV loading device mounted on an ATV with a load in a further elevated intermediate position;

FIG. 12 is a side-elevational view of an embodiment of the ATV loading device mounted on an ATV with a load in a still further elevated intermediate position;

FIG. 13 is a side-elevational view of an embodiment of the ATV loading device mounted on an ATV with a load in a fully-elevated, loaded position.

FIG. 14 is a perspective view of primary frame component and bumper saddle portions of an embodiment of the ATV loading device;

FIG. 15 is an exploded perspective view of bumper saddle and saddle plate portions of an embodiment of the ATV loading device;

FIG. 16 is a exploded side-elevational view of bumper saddle and saddle plate portions of an embodiment of the ATV loading device;

FIG. 17 is a perspective view of the bumper saddle portion of an embodiment of the ATV loading device;

FIG. 18 is a side-elevational view of the bumper saddle portion of an embodiment of the ATV loading device;

FIG. 19 is a perspective view of detachable basket support arm and detachable basket portions of an embodiment of the ATV loading device;

FIG. 19A is an exploded perspective view of detachable basket support arm and detachable basket portions of an embodiment of the ATV loading device;

FIG. 20 is an exploded top view of detachable basket support arm and detachable basket portions of an embodiment of the ATV loading device; and

FIG. 21 is a top view of detachable basket support arm and detachable basket portions of an embodiment of the ATV loading device.

### DETAILED DESCRIPTION

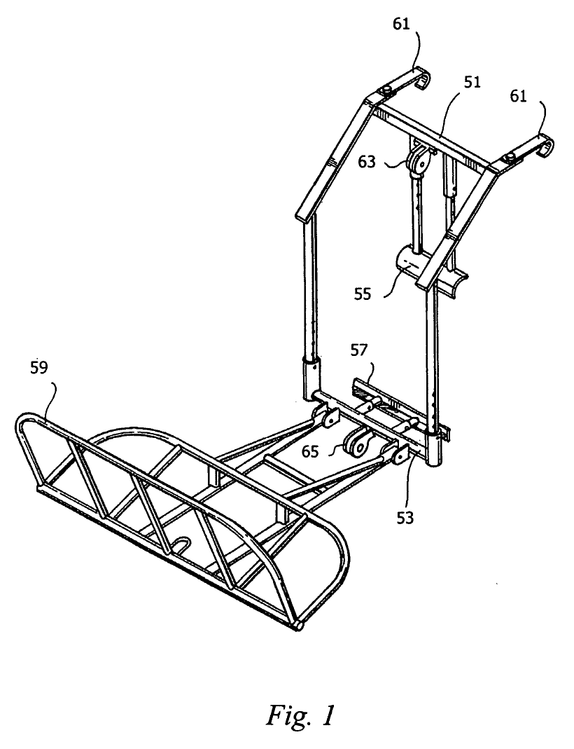

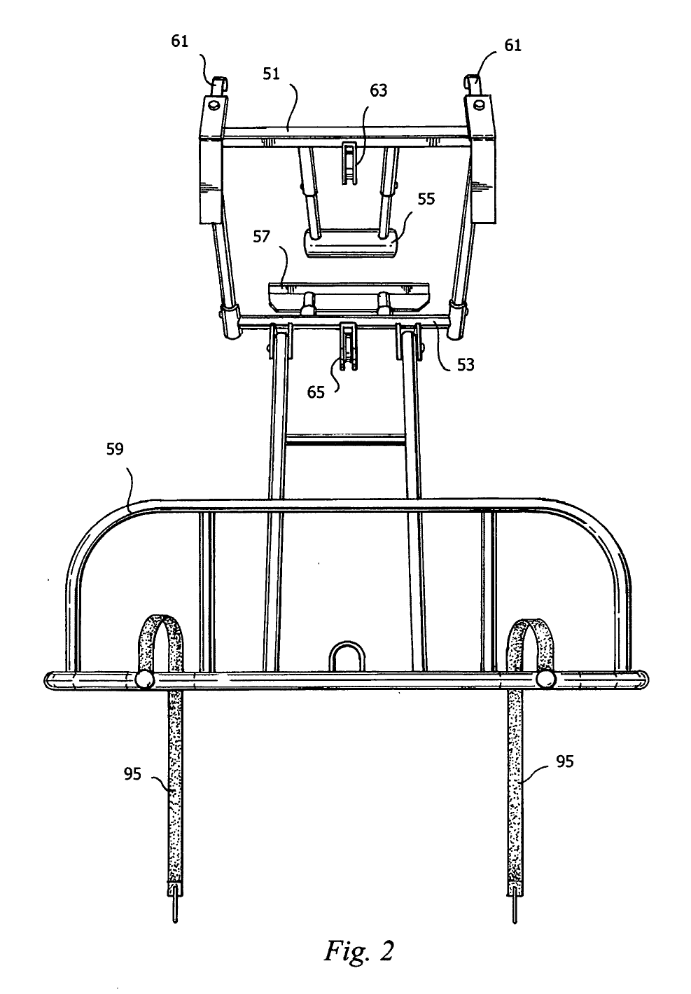

Referring to the drawings, and particularly to FIGS. 1 and 2 thereof, an embodiment of the ATV loading device comprises a primary frame component 51, secondary frame component 53, bumper saddle 55, saddle plate 56, bumper positioning component 57, detachable basket support arm 58, and detachable basket 59. The primary frame component 51 terminates in hooks 61 at its upper end. The hooks 61 can be coupled to the primary frame component 51, as discussed below, or integrated with the primary frame component 51. Pulleys 63 and 65 are mounted to the primary frame component 51 and the secondary frame component 53 respectively. The components can be constructed of steel or synthetic materials, the proper materials being well known to those having skill in the art.

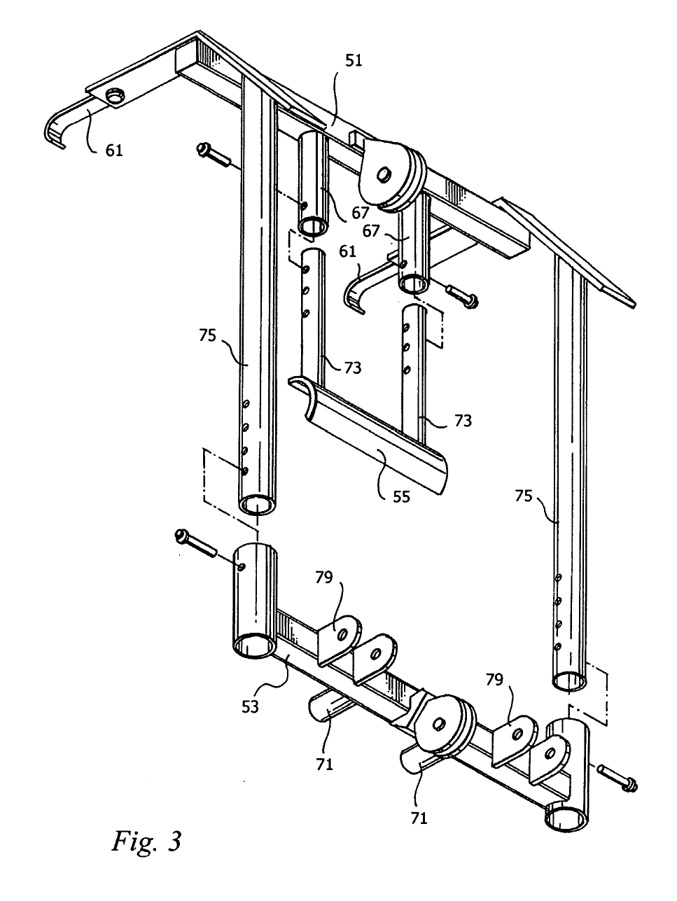

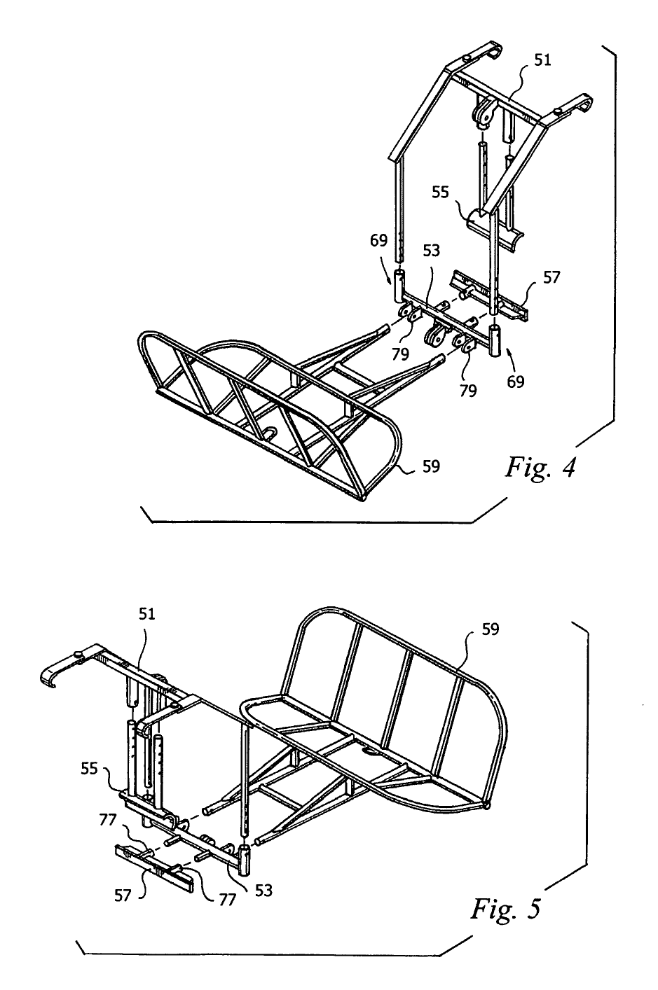

FIG. 3 shows an exploded view of the primary frame component 51, secondary frame component 53, and bumper saddle 55. FIGS. 4 and 5 show exploded views of the primary frame component 51, secondary frame component 53, bumper saddle 55, bumper positioning component 57, and detachable basket 59. Except for the detachable basket support arm 58 and detachable basket 59, all of the components shown in FIGS. 3-5 engage each other via male-female type connections and are coupled together by nuts and bolts, PTO type pins, or other such coupling means commonly known in the art, at holes disposed in the respective connection points of the component parts.

Again focusing on FIGS. 3-5, bumper saddle engaging members 67 of the primary frame component 51, vertical portions 69 of the secondary frame component 53, and bumper positioning component engaging members 71 of the secondary frame component 53 are configured as the female connector portions of the male-female connection. Vertical portions 73 of the bumper saddle 55, vertical portions 75 of the primary frame component 51, and secondary frame component engaging members 77 of the bumper positioning component 57 are configured as the male connector portions of the male-female connection.

The orientation of the respective male-female connectors can also be reversed so that the bumper saddle engaging members 67 of the primary frame component 51, vertical portions 69 of the secondary frame component 53, and bumper positioning component engaging members 71 of the secondary frame component 53 are configured as the male connector portions of the male-female connection, and vertical portions 73 of the bumper saddle 55, vertical portions 75 of the primary frame component 51, and secondary frame component engaging members 77 of the bumper positioning component 57 are configured as the female connector portions of the male-female connection.

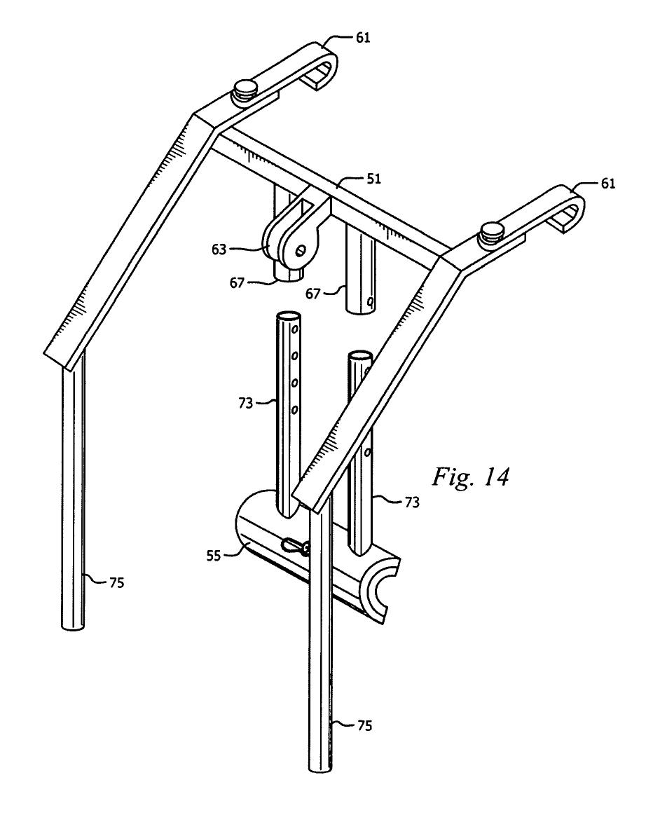

As shown in FIGS. 3-5 and 14-16, the vertical portions 75 of the primary frame component 51, vertical portions 73 of the bumper saddle 55, and secondary frame component engaging members 77 of the bumper positioning component 57 are disposed with a plurality of holes so as to allow adjustments to be made to the length/depth of the respective components, thus allowing the ATV loading device to be compatible with multiple makes and models of ATVs. For example if a shorter component is necessary, the component is inserted further into the respective female connector, and the coupling means is aligned with the corresponding hole. Likewise, if a longer component is necessary, the component is inserted a shorter length into the respective female connector, and the coupling means is aligned with the corresponding hole.

Should the orientation of the respective male-female connectors be reversed as discussed heretofore, the bumper saddle engaging members 67 of the primary frame component 51, vertical portions 69 of the secondary frame component 53, and bumper positioning component engaging members 71 of the secondary frame component 53 are disposed with the plurality of holes, adjustments to the length of the respective components being made accordingly.

Other means of engagement between the components depicted in FIGS. 3-5 and 14-16 are also envisioned, such as various locking mechanisms, latching mechanisms, ratcheting mechanisms, hydraulic means, means for slidably engaging the components, means for engaging the components at a joint, etc., such means of engagement being well known to those having skill in the art.

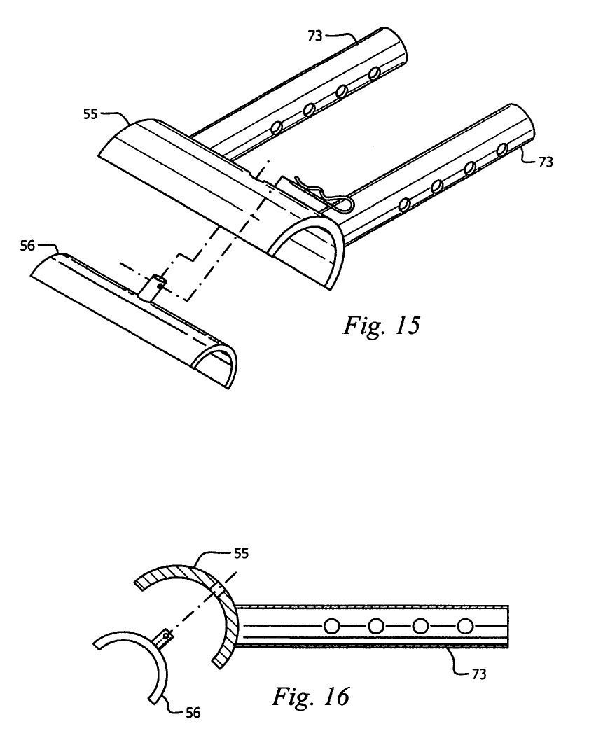

To support adaptation of the ATV loading device to multiple makes and models of ATVs, the bumper saddle 55 mates to a saddle plate 56 as shown in FIGS. 15-16, thereby securing the ATV loading device to ATVs having radially small bumpers. The saddle plate 56 comprises a concave formation or other structural formation capable of embracing small radial bumpers and a stud protruding therefrom, wherein the end of the stud comprises a hole for receiving a pin or the like. The bumper saddle 55 comprises an aperture for receiving the stud of the saddle plate 56. Once the aperture of the bumper saddle 55 receives the stud of the saddle plate 56, a pin, hitch pin, or the like is utilized to lock the stud into place, thereby affixing the saddle plate 56 to the bumper saddle 55.

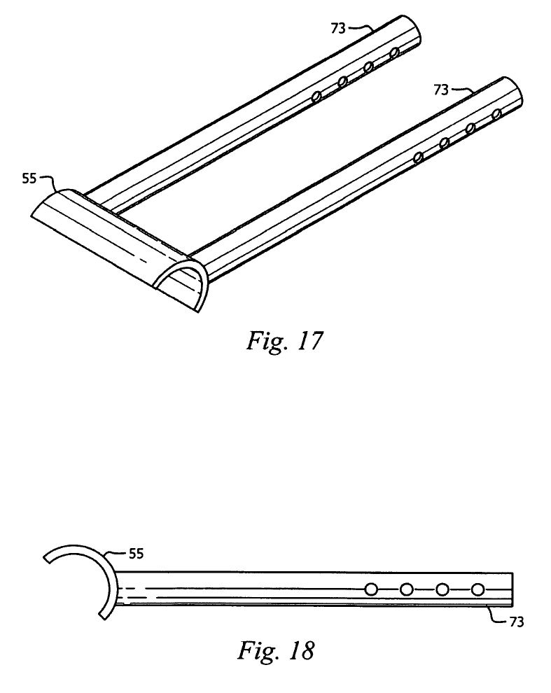

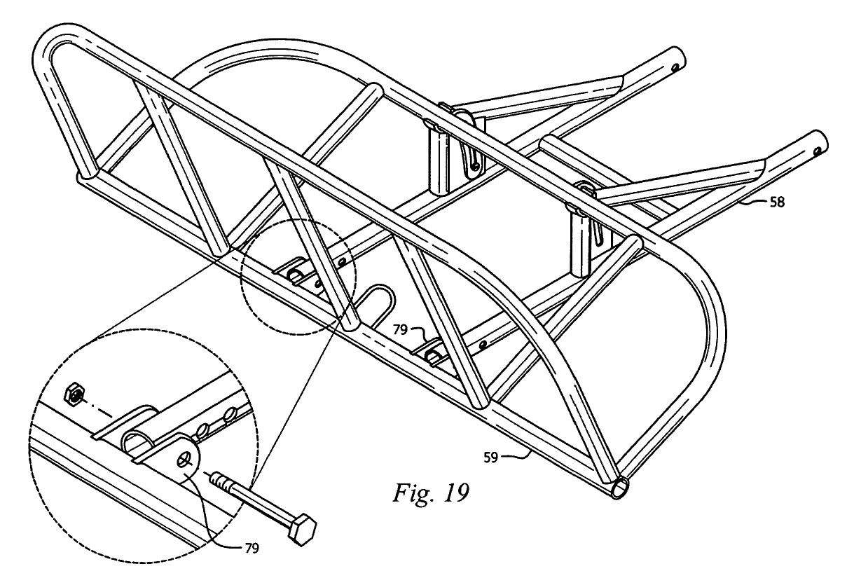

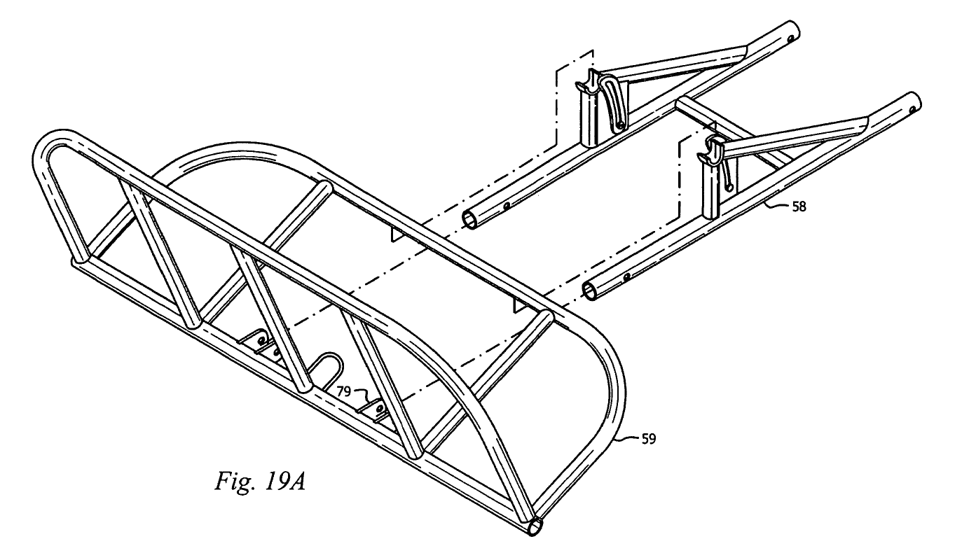

As shown in FIGS. 17-18, the ATV loading device alternatively features a bumper saddle 55 comprising vertical portions 73 having increased longitudinal dimensions. Because ATV bumper placements vary from model to model, the increased longitudinal vertical portions 73 ensure that the ATV loading device fits the many different types of ATV makes and models.

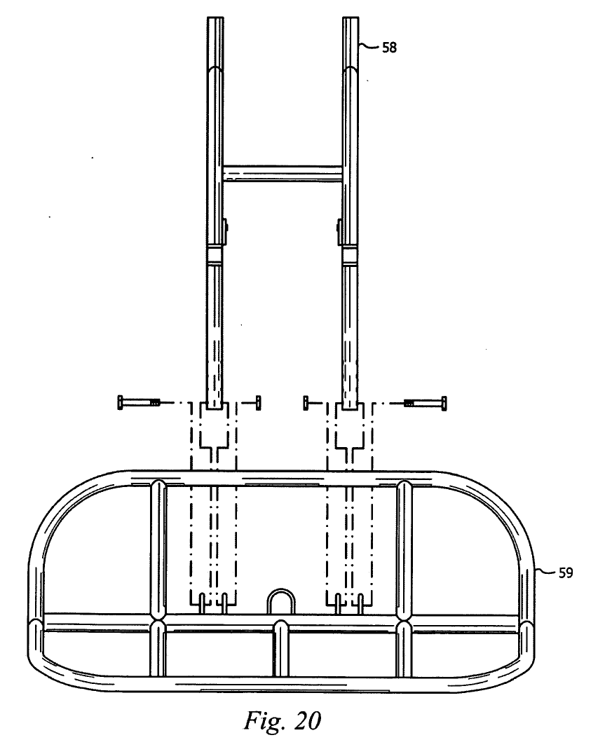

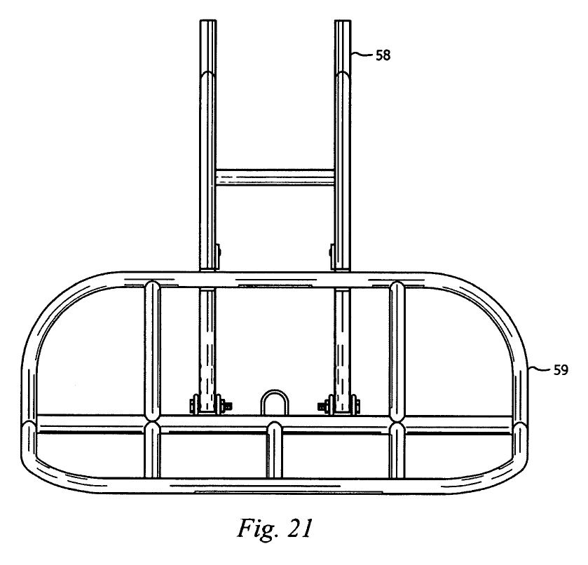

As shown in FIGS. 3-5 and 19-21, an end of the detachable basket support arm 58 pivotally attaches to the secondary frame component 53 and the other end of the detachable basket support arm 58 immovably attaches to the detachable basket 59. Each respective end attaches thereto via U-joints 79 in combination with nuts and bolts, PTO type pins, or other such coupling means commonly known in the art. Alternatively, the U-joints can be set on the detachable basket support arm 58 with extensions capable of being coupled to the U-joints extending from the secondary frame component 53. The detachable basket support arm 58 comprises receivers that receive the tubing or other structural component from the detachable basket 59, thereby locking the detachable basket 59 in an upright position.

The detachable basket support arm 58 supports the detachable basket 59 as well as other types of accessories. For example, the detachable basket support arm 58 can attach to accessories such as but not limited to a seed/fertilizer/seed spreader, animal transport basket, dump bucket, post remover, hay fork, oversized dump box, and self leveling basket. As such, the ATV loading device can be used to accomplish many different types of tasks.

Additionally, the detachability of the detachable basket 59 ensures significantly smaller packaging when shipping to customers, thus reducing shipping cost. Therefore, the design of the ATV loading device provides for the attachment of many different component parts to the detachable basket support arm 58 and facilitates cost savings when shipping due to smaller packaging.

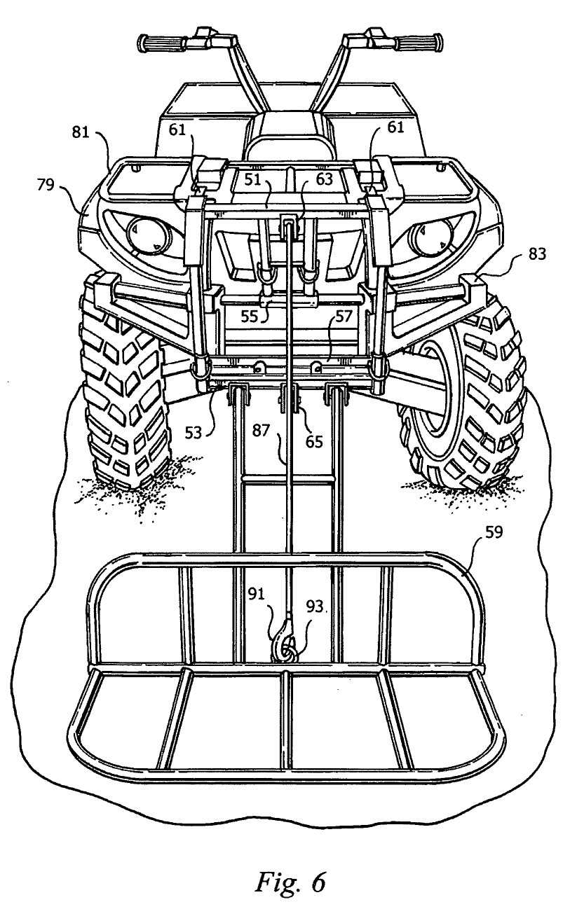

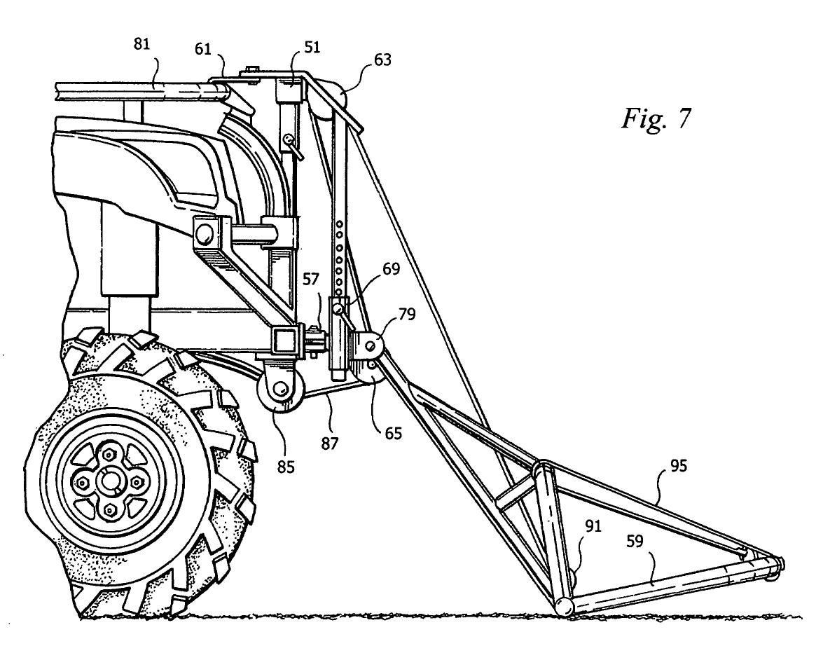

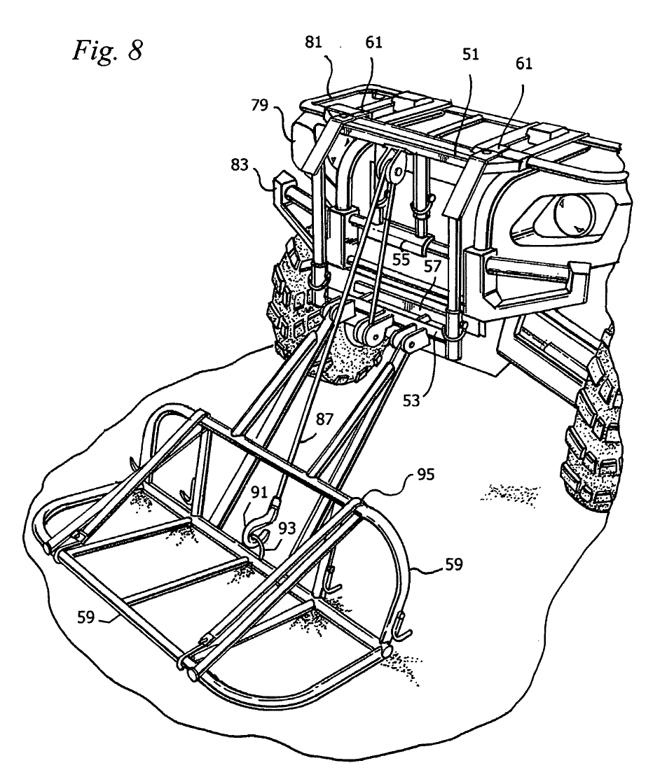

The ATV loading device is installed on an ATV 79 as shown in FIGS. 6-8. The hooks 61 are first coupled to the primary frame component 51 with nuts and bolts, PTO type pins, or other such coupling means commonly known in the art. The hooks 61 are coupled to the primary frame component 51 through a hole disposed in the hooks 61 and the primary frame component 51 respectively. Alternatively, the hooks 61 could be integrated with the primary frame component 51. The hooks 61 are then hooked to a rack 81 of the ATV 79. The hooks 61 are capable of swinging movement so as to allow them to be hooked to different styles of racks depending on the make and model of the ATV on which the ATV loading device is being installed.

Once the hooks 61 are hooked to the rack 81, the primary frame component 51 is in position. The bumper saddle 55 can then be adjusted to accommodate the bumper 83 of the ATV 79 on which the ATV loading device is being installed. As discussed heretofore, the bumper saddle 55 can be raised and lowered via holes disposed therein, replaced with bumper saddle 55 having substantially longer vertical portions 73, or mated to saddle plate 56 to accommodate different makes and models of ATVs. With the hooks 61 remaining level, the bumper saddle 55 is positioned against the ATV bumper 83 and coupled to the primary frame component 51, thus locking it in place.

The secondary frame component 53 is set above a winch 85 of the ATV 79. The secondary frame component 53 is set so that the pulley 65 is positioned above the area where a cable 87 of the winch 85 extends from the ATV 79, above the fairlead of the winch 85. The secondary frame component 53 is set as low as possible so as to still remain positioned above the winch 85. The secondary frame component 53 can then be coupled to the primary frame component 51 and locked in place.

The bumper positioning component 57 is then adjusted to the necessary depth so as to rest on the bumper 83 at the supports or the lowest brace positioned above the winch 85. The bumper positioning component 57 can then be coupled to the secondary frame component 53 and locked in place.

Generally, the bumper positioning component 57 will rest on the ATV's bumper 83 proximately centered on the tubing or cross brace of the bumper 83. On ATV models where the bumper does not have a brace to center the bumper positioning component 57, the bumper positioning component 57 is positioned so as to overlap the vertical tubing of the bumper 83. The bumper positioning component 57 is then coupled to the secondary frame component 53 and locked in place. In addition, the bumper positioning component 57 can have various shapes and construction so as to be compatible with the bumpers of different makes and models of ATVs.

With the aforementioned components of the ATV loading device in place, the detachable basket support arm 58 is then attached to the secondary frame component 53. Subsequently, the detachable basket 59 is attached to the detachable basket support arm 58. Then, the cable 87 of the winch 85 is routed over the outside of the pulley 65 of the secondary frame component 53 and through the pulley 63 of the primary frame component 51 by removing the pin from the pulley 63. The cable 87 is then routed under the basket 59 and a hook 91 of the cable 87 is hooked to a hook loop 93 of the detachable basket 59.

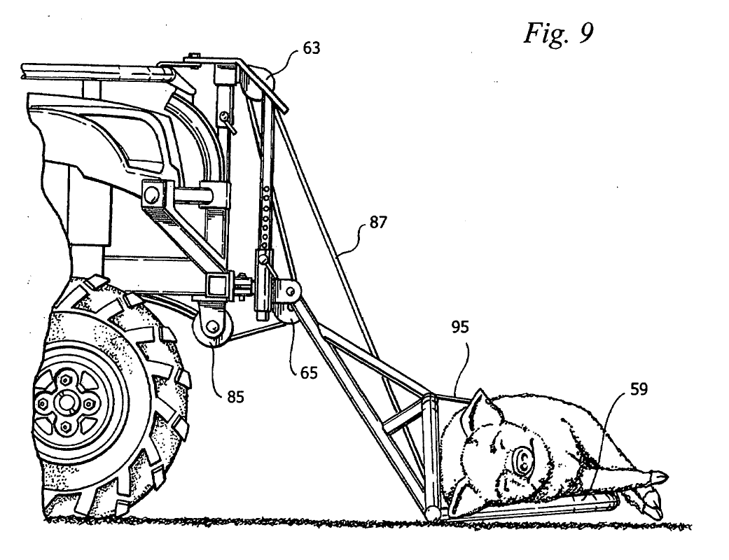

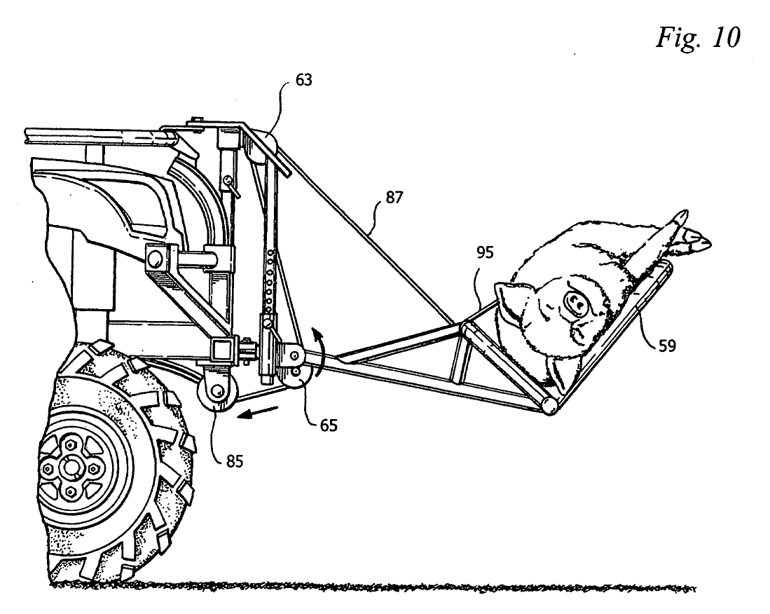

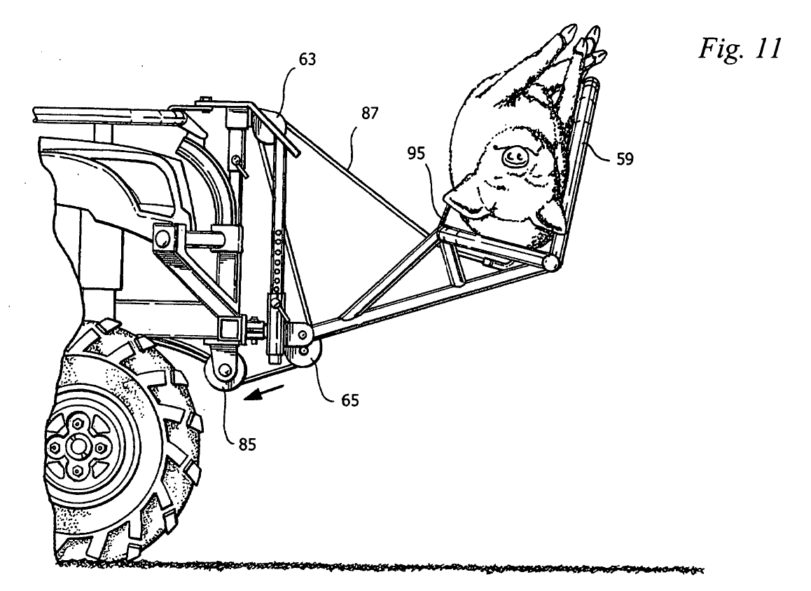

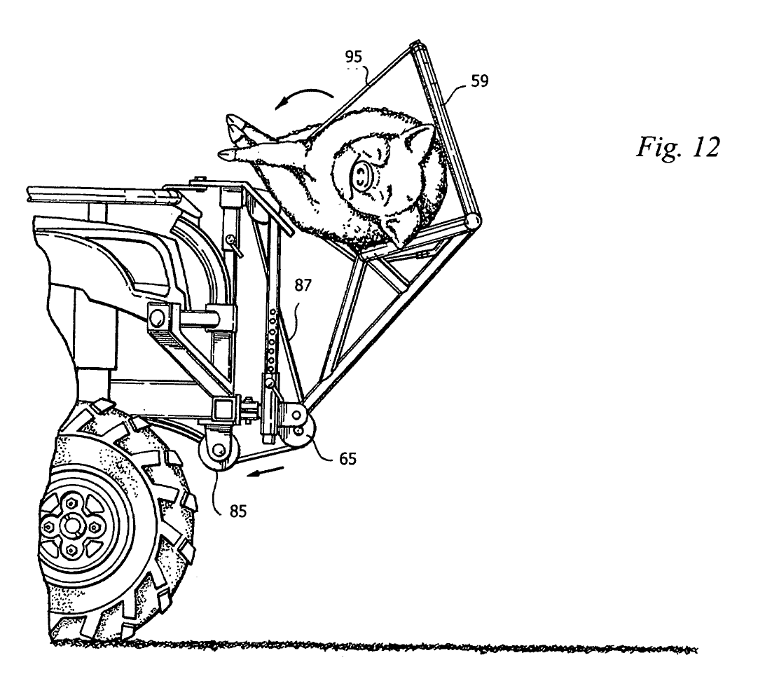

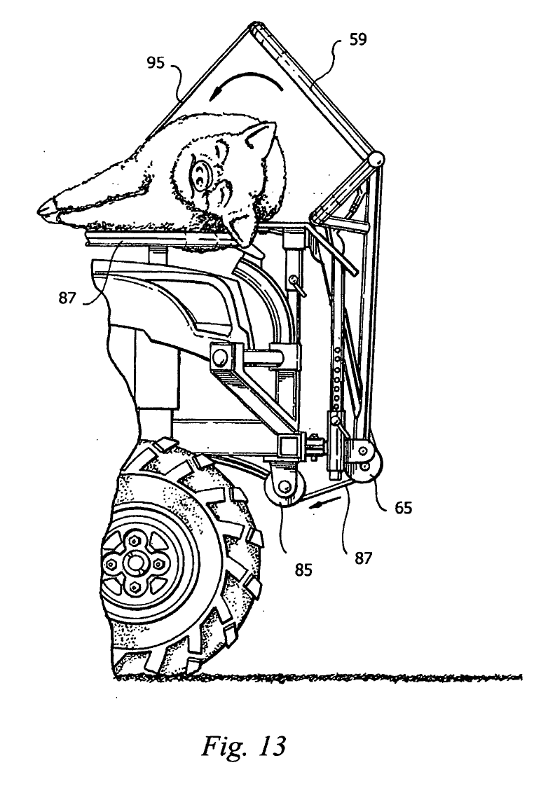

The ATV loading device can then be operated. The detachable basket 59 or other type of accessory will raise and lower in connection with operation of the winch 85 as shown in FIGS. 9-13. By utilizing straps 95, the detachable basket 59 or other type of accessory can be held in a tightened, stationary position when the winch 85 is drawn completely inward and the detachable basket 59 is in its full upright position as shown in FIG. 13, although tension created by the winch will hold the basket 59 firmly in place. In this manner the load can be transported as shown in FIG. 13.

By utilizing a locking means, such as a lock bar, the detachable basket 59 or other type of accessory can be locked in place in the open position. Winch tension is placed against the lock bar to ensure the primary frame component 51 will not become detached from its mounting position. Utilization of the lock bar increases the size of the load that can be handled by the ATV loading device. For instance, a swiveling hook arrangement can be utilized to configure the detachable basket 59 to carry buckets or other such containers. This also increases the cargo capacity, as the remaining carrying surface of the detachable basket 59 is left open.

The ATV loading device can be removed by disconnecting the hook 61 from the hook loop 93, removing the cable 87 from the pulley 63, and lifting upward on the primary frame component 51 while tilting the hooks 61 back towards the ATV 79. Further, the straps 95 are useful for storing the ATV loading device. Before removal of the ATV loading device, the straps 95 can be wrapped around the detachable basket 59 or other type of accessory and the primary frame component 51. This will hold the detachable basket 59 or other type of accessory and the primary frame component 51 together for storage.

Although preferred embodiments of the invention have been illustrated in the accompanying Drawings and described in the foregoing Summary and Detailed Description, it will be understood that the invention is not limited to the embodiments disclosed, but is capable of numerous rearrangements, modifications, and substitutions of parts and elements without departing from the spirit of the invention.

1. An ATV loading device for loading and transporting objects using an ATV, comprising:
a primary frame component having horizontally disposed hooks for engaging a rack on the ATV, having vertical portions, and having bumper saddle engaging members;
a secondary frame component attached to the primary frame component, the secondary frame component having vertical portions and bumper positioning component engaging members wherein vertical portions of the secondary frame component attach to vertical portions of the primary frame component;
a bumper positioning component attached to the secondary frame component for bracing the ATV loading device against a bumper of an ATV, the bumper positioning component having secondary frame component engaging members wherein secondary frame component engaging members attach to bumper positioning component engaging members of the secondary frame component;
a bumper saddle attached to the primary frame component for bracing the ATV loading device against a bumper of an ATV, the bumper saddle having vertical portions wherein vertical portions attach to bumper saddle engaging members of the primary frame component;
a detachable basket support arm pivotally attached to the secondary frame component, the detachable basket support arm having horizontal portions and a plurality of receivers; and
a detachable basket removably attached to horizontal portions of the detachable basket support arm and received by the receivers of the detachable basket support arm for loading and transporting objects.

2. The ATV loading device for loading and transporting objects using an ATV of claim 1 further comprising a saddle plate attached to the bumper saddle for securing the ATV loading device to bumpers having small radial dimensions.

3. The ATV loading device for loading and transporting objects using an ATV of claim 2 wherein the saddle plate comprises a stud protruding therefrom and the bumper saddle comprises an aperture for receiving the stud of the saddle plate.

4. The ATV loading device for loading and transporting object using an ATV of claim 2 wherein the bumper saddle and saddle plate comprise a concave formation capable of embracing the radial bumper of an ATV;

5. The ATV loading device for loading and transporting objects using an ATV of claim 1 wherein the vertical portions of the primary frame component, the vertical portions of the bumper saddle, and the secondary frame component engaging members of the bumper positioning component are disposed with a plurality of holes to allow adjustments to the length of the respective components.

6. The ATV loading device for loading and transporting objects using an ATV of claim 1 wherein the primary frame component, secondary frame component, bumper saddle, and bumper positioning component engage each other via male-female type connections.

7. The ATV loading device for loading and transporting objects using an ATV of claim 1 wherein the primary frame component, secondary frame component, bumper positioning component, bumper saddle, detachable basket support arm, and detachable basket are manufactured from steel.
